(19) United States
(12) Patent Application Publication
(10) Pub. No.: US 2008/0053477 A1
(43) Pub. Date: Mar. 6, 2008

(54) Dental Floss Formed From Botanic Fiber

(76) Inventors: W.E. LeGrande, Reading, PA (US); Ali M. Evazynajad, Langhorne, PA (US)

Correspondence Address: WOMBLE CARLYLE SANDRIDGE & RICE, PLLC, ATTN: PATENT DOCKETING 32ND FLOOR, P.O. BOX 7037, ATLANTA, GA, 30357-0037, US

(21) Appl. No.: 11/773,073

(22) Filed: Jul. 3, 2007

Related U.S. Application Data
(60) Provisional application No. 60/806,495, filed on Jul. 3, 2006.

(51) Int. Cl. A61C 15/04; D02G 3/04

(52) U.S. Cl. 132/321; 428/377

(57) ABSTRACT

A dental implement comprising a botanic fiber is disclosed. The dental implement can be a dental floss. A floss formed of a blend of botanic fiber and silk is also disclosed. In one aspect, the botanic fiber is soybean protein fiber. Various blends of soybean protein fiber and silk are disclosed.

### PRIORITY APPLICATION

This application claims the benefit of U.S. Provisional Application No. 60/806,495, filed Jul. 3, 2006, which is hereby incorporated by reference in its entirety.

### TECHNICAL FIELD

The present invention relates generally to implements for use in dental hygiene and, more particularly, to dental floss.

### BACKGROUND

The use of dental floss to facilitate oral and dental hygiene is well known in the art. Many types of dental floss have been made available commercially. Nonetheless, there remains a need for an improved dental floss.

### SUMMARY

This disclosure describes a dental floss formed at least partially from soybean protein fiber or other botanic fibers. Soybean protein fiber is a botanic fiber derived from the soybean, a plant rich in nutrition and amino acid. Thus, derivatives of soybean protein fiber also include such ingredients. Furthermore, derivates of soybean protein fiber, for example, dental floss, may be biodegradable.

In one example, the invention is directed to a dental floss comprising a blend of soybean fiber and silk. By combining soybean protein fiber with silk, the strength and lubricity of the floss may be enhanced.

A dental floss formed at least partially from soybean protein fiber generally is soft and smooth. The natural color of soybean protein fiber is ivory; however, the color can change depending on the type of coating applied to the floss.

### DESCRIPTION

The present invention is a dental floss or dental tape (collectively “floss”) formed at least partially from a botanic fiber. In one aspect, the botanic fiber is soybean protein fiber formed into a soybean thread. Although soybean protein fiber is discussed in detail herein and represents the best mode known to the inventors for carrying out the invention, it will be understood that other botanic fibers may be used as desired.

If desired, various other constituents may be used in combination with botanic fiber to form dental floss in accordance with the invention. Such other constituents may be natural or synthetic and may be present in any suitable amount needed to attain the desired aesthetic and functional characteristics of dental floss.

Thus, the floss may have any suitable botanic fiber content as needed for a particular application. More particularly, the botanic fiber content may be greater than 0 wt % up to 100 wt %. In each of various independent examples, the floss may have a botanic fiber content of greater than 0 wt % to about 10 wt %, from about 10 wt % to about 20 wt %, from about 20 wt % to about 30 wt %, from about 30 wt % to about 40 wt %, from about 40 wt % to about 50 wt %, from about 50 wt % to about 60 wt %, from about 60 wt % to about 70 wt %, from about 70 wt % to about 80 wt %, from about 80 wt % to about 90 wt %, or from about 90 wt % to 100 wt %. Numerous other ranges are contemplated by the invention.

Likewise, where other fibers are used, such other fibers may be present in any suitable amount. Thus, in each of various examples, each other type of fiber independently may be present in an amount of from greater than 0 wt % to about 10 wt %, from about 10 wt % to about 20 wt %, from about 20 wt % to about 30 wt %, from about 30 wt % to about 40 wt %, from about 40 wt % to about 50 wt %, from about 50 wt % to about 60 wt %, from about 60 wt % to about 70 wt %, from about 70 wt % to about 80 wt %, from about 80 wt % to about 90 wt %, or from about 90 wt % to 100 wt %.

In one example, the floss includes a combination of botanic fiber and silk. In various independent examples, the floss may have a silk content of from greater than 0 wt % to about 10 wt %, from about 10 wt % to about 20 wt %, from about 20 wt % to about 30 wt %, from about 30 wt % to about 40 wt %, from about 40 wt % to about 50 wt %, from about 50 wt % to about 60 wt %, from about 60 wt % to about 70 wt %, from about 70 wt % to about 80 wt %, from about 80 wt % to about 90 wt %, or from about 90 wt % to 100 wt %.

In a variation of this example, the botanic fiber comprises soybean protein fiber. Each of the components may be present in any suitable amount, for example, greater than 0 wt % to less than 100 wt %. In one example, the floss has a botanic fiber content of from greater than 0 wt % to about 10 wt % and a silk content of from less than 100 wt % to about 90 wt %. In another example, the floss has a botanic fiber content of from about 10 wt % to about 20 wt % and a silk content of from less than about 90 wt % to about 80 wt %. In another example, the floss has a botanic fiber content of from about 20 wt % to about 30 wt % and a silk content of from less than about 80 wt % to about 70 wt %. In another example, the floss has a botanic fiber content of from about 30 wt % to about 40 wt % and a silk content of from less than about 70 wt % to about 60 wt %. In another example, the floss has a botanic fiber content of from about 40 wt % to about 50 wt % and a silk content of from less than about 60 wt % to about 50 wt %. In another example, the floss has a botanic fiber content of from about 50 wt % to about 60 wt % and a silk content of from less than about 50 wt % to about 40 wt %. In another example, the floss has a botanic fiber content of from about 60 wt % to about 70 wt % and a silk content of from less than about 40 wt % to about 30 wt %. In another example, the floss has a botanic fiber content of from about 70 wt % to about 80 wt % and a silk content of from less than about 30 wt % to about 20 wt %. In a further example, the floss has a botanic fiber content of from about 80 wt % to about 90 wt % and a silk content of from less than about 20 wt % to about 10 wt %. In yet another example, the floss has a botanic fiber content of from about 90 wt % to 100 wt % and a silk content of from less than about 10 wt % to greater than 0 wt %.

Thus, in each of various examples, the floss may have a weight ratio of botanic fiber to silk of about 1:1, about 1:2, about 1:3, about 1:4, about 1:5, about 1:6, about 1:7, about 1:8, about 1:9, about 1:10, about 1:11, about 1:12, about 1:13, about 1:14, about 1:15, about 1:20; about 2:1, about 2:3, about 2:5, about 2:7, about 2:9, about 2:11, about 2:13, about 2:15, about 3:1, about 3:2, about 3:4, about 3:5, about 3:7, about 3:8, about 3:10, about 3:11, about 3:13, about 3:14, about 4:1, about 4:3, about 4:5, about 4:7, about 4:9, about 4:11, about 4:13, about 4:15, about 5:1, about 5:2, about 5:3, about 5:4, about 5:6, about 5:7, about 5:8, about 5:9, about 5:11, about 5:12, about 5:13, about 5:14, about 6:1, about 6:5, about 6:7, about 6:11, about 6:13, about 6:14, about 6:15, about 7:1, about 7:2, about 7:3, about 7:4, about 7:5, about 7:6, about 7:8, about 7:9, about 7:10, about 7:11, about 7:12, about 7:13, about 7:15, about 8:1, about 8:3, about 8:5, about 8:7, about 8:9, about 8:11, about 8:13, about 8:15, about 9:1, about 9:2, about 9:4, about 9:5, about 9:7, about 9:8, about 9:10, about 9:11, about 9:13, about 9:14, about 10:1, about 10:3, about 10:7, about 10:9, about 10:11, about 10:13, or any other suitable ratio.

Thus, in each of other various examples, the floss may have a weight ratio of silk to botanic fiber of about 1:1, about 1:2, about 1:3, about 1:4, about 1:5, about 1:6, about 1:7, about 1:8, about 1:9, about 1:10, about 1:11, about 1:12, about 1:13, about 1:14, about 1:15, about 1:20; about 2:1, about 2:3, about 2:5, about 2:7, about 2:9, about 2:11, about 2:13, about 2:15, about 3:1, about 3:2, about 3:4, about 3:5, about 3:7, about 3:8, about 3:10, about 3:11, about 3:13, about 3:14, about 4:1, about 4:3, about 4:5, about 4:7, about 4:9, about 4:11, about 4:13, about 4:15, about 5:1, about 5:2, about 5:3, about 5:4, about 5:6, about 5:7, about 5:8, about 5:9, about 5:11, about 5:12, about 5:13, about 5:14, about 6:1, about 6:5, about 6:7, about 6:11, about 6:13, about 6:14, about 6:15, about 7:1, about 7:2, about 7:3, about 7:4, about 7:5, about 7:6, about 7:8, about 7:9, about 7:10, about 7:11, about 7:12, about 7:13, about 7:15, about 8:1, about 8:3, about 8:5, about 8:7, about 8:9, about 8:11, about 8:13, about 8:15, about 9:1, about 9:2, about 9:4, about 9:5, about 9:7, about 9:8, about 9:10, about 9:11, about 9:13, about 9:14, about 10:1, about 10:3, about 10:7, about 10:9, about 10:11, about 10:13, or any other suitable ratio.

While silk is described herein in detail, it will be understood that various other constituents may be used in accordance with the invention. Examples of other constituents include, but are not limited to, one or more polymers or polymeric materials, natural fibers, for example, cotton or wool, flax, bamboo, synthetic fibers, or any combination thereof, in any proportion.

As used herein the term “polymer” or “polymeric material” includes, but is not limited to, homopolymers, copolymers, for example, block, graft, random, and alternating copolymers, terpolymers, etc., and blends and modifications thereof. Furthermore, unless otherwise specifically limited, the term “polymer” includes all possible geometrical configurations of the molecule. These configurations include, but are not limited to isotactic, syndiotactic, and random symmetries. Examples of polymers that may be suitable for use with the present invention include, but are not limited to, polycarbonate; polyolefins, for example, polyethylene, polypropylene, polybutylene, and copolymers thereof; polytetrafluoroethylene; polyesters, for example, polyethylene terephthalate, for example, coextruded polyethylene terephthalate; vinyl polymers, for example, polyvinyl chloride, polyvinyl alcohol, ethylene vinyl alcohol, polyvinylidene chloride, polyvinyl acetate, polyvinyl chloride acetate, polyvinyl butyral; acrylic resins, for example, polyacrylate, polymethylacrylate, and polymethylmethacrylate; polyamides, for example, nylon 6 or nylon 6,6; polystyrenes; polyurethanes; cellulosic resins, for example, cellulosic nitrate, cellulosic acetate, cellulosic acetate butyrate, ethyl cellulose; copolymers of any of the above materials; or any blend or combination thereof.

The dental floss may be formed in any suitable manner, for example, from one or more staple fibers, one or more filaments, or any combination thereof, that are twisted, knitted, entangled, braided, woven, non-woven, or otherwise processed to form a unitary structure or yarn. Each individual fiber or filament used to form the dental floss may be formed from a single constituent (“monoconstituent”) or may be formed from a blend or other arrangement of multiple constituents (“multiconstituent”). Likewise, the dental floss formed from the individual fibers and/or filaments may be monoconstituent or multiconstituent. Thus, the invention contemplates a dental floss formed from any combination or blend of monoconstituent fibers, monoconstituent filaments, multiconstituent fibers, and multiconstituent filaments.

Where the floss is formed from one or more multiconstituent fibers or filaments, each fiber or filament independently may comprise from 0 wt % to 100 wt % botanic fiber, for example, soybean protein fiber. More particularly, each fiber independently may comprise 0 wt % to about 10 wt % botanic fiber, about 10 wt % to about 20 wt % botanic fiber, from about 20 wt % to about 30 wt % botanic fiber, from about 30 wt % to about 40 wt % botanic fiber, from about 40 wt % to about 50 wt % botanic fiber, from about 50 wt % to about 60 wt % botanic fiber, from about 60 wt % to about 70 wt % botanic fiber, from about 70 wt % to about 80 wt % botanic fiber, from about 80 wt % to about 90 wt % botanic fiber, or from about 90 wt % to 100 wt % botanic fiber.

Likewise, where the floss is formed at least partially from silk, each fiber or filament independently may comprise from 0 wt % to 100 wt % silk. More particularly, each fiber independently may comprise 0 wt % to about 10 wt % silk, about 10 wt % to about 20 wt % silk, from about 20 wt % to about 30 wt % silk, from about 30 wt % to about 40 wt % silk, from about 40 wt % to about 50 wt % silk, from about 50 wt % to about 60 wt % silk, from about 60 wt % to about 70 wt % silk, from about 70 wt % to about 80 wt % silk, from about 80 wt % to about 90 wt % silk, or from about 90 wt % to 100 wt % silk.

If desired, various additives may be used to impart, flavor, anti-static properties, lubricity, hydrophilicity, or any other property to the individual fibers or filaments. Such additives may be used in an amount of from about 0.1 wt % to about 20 wt %, for example, from about 5 wt % to about 10 wt %, of the fiber or filament.

Likewise, a functional or aesthetic coating may be applied to and/or overlie at least a portion of the floss. Examples of such coatings that may be suitable include, but are not limited to, surfactants, fluoridating treatments, medicinal agents, antimicrobial agents, flavorings, coatings that alter the coefficient of friction of the floss, for example, wax, combinations including wax, or any other coating or treatment, as needed or desired.

The coating or treatment may be applied to the individual fibers, filaments, floss, or blended floss using any suitable technique, method, or process. Examples of processes that may be used include, but are not limited to, gravure printing, roll coating, brush treating, spraying, dipping, coating with wire wound rods, or any combination thereof. Alternatively, the treatment may be incorporated into the fiber or filament as an additive, for example, within any polymeric fibers, such that the additive diffuses to the surface thereof to form the coating.

The amount of coating used may vary for a particular application. Generally, the coating may be applied in an amount of from about 0.25% to about 40% of the weight of the fiber, filament, floss, or blended floss on a dry basis. In one aspect, the coating may be applied in an amount of from about 1% to about 38% of the weight of the fiber, filament, floss, or blended floss on a dry basis. In another aspect, the coating may be applied in an amount of from about 5% to about 35% of the weight of the fiber, filament, floss, or blended floss on a dry basis. In still another aspect, the coating may be applied in an amount of from about 0.25% to about 1% of the weight of the fiber, filament, floss, or blended floss on a dry basis. However, other coating weights are contemplated hereby.

In one aspect, the coating comprises a natural or synthetic bond. To apply the bond, the fibers, filament, floss, or blended floss may be dipped into a bath containing a softened bond, typically maintained at a desired temperature. If desired, the bath may contain natural or artificial flavors. The bond can include wax, chemical, solutions, water based solutions, non-water based solutions, or powders. The solidified bond tends to reduce the coefficient of friction of the fibers, filament, floss, or blended floss and, as a result, allows the floss to slide more easily between the teeth to reduce the likelihood of injury to the gums. For example, the floss or blended floss may have a coefficient of friction of from about 0.08 to about 0.25, or the bond can be used to obtain the desired aesthetic and functional characteristics of dental floss or tape.

A floss formed from the fiber or filament used in accordance with the present invention may have any suitable tensile strength and elongation. Further, a blended floss formed from the fiber or filament and silk used in accordance with the present invention may have any suitable tensile strength and elongation. In one aspect, the blended floss has a tensile strength of at least about 4.0 grams/denier. In another aspect, the blended floss has a tensile strength of at least about 4.15 grams/denier. In yet another aspect, the blended floss has a tensile strength of at least about 4.25 grams/denier. In one particular aspect, the blended floss has a tensile strength of about 4.29 grams/denier. However, other tensile strengths are contemplated.

Likewise, the fiber or filament may have a peak elongation of at least about 18%. In one aspect, the fiber or filament has a peak elongation of at least about 19%. In another aspect, the fiber or filament has a peak elongation of at least about 20%. In still another aspect, the fiber or filament has a peak elongation of at least about 21%. However, other peak elongations are contemplated hereby.

The thread length for the dental floss is determined by the amount of thread that can be wound on the selected bobbin. However, other types of dental floss can be used, such as coreless dental floss, where no bobbin is required. The wound dental floss then is packed into a dispensing container. Any suitable container may be used, including various shapes, styles, and colors.

It will be recognized by those skilled in the art, that various elements discussed with reference to the various embodiments may be interchanged to create entirely new embodiments coming within the scope of the present invention. It also will be readily understood that, in view of the above detailed description of the invention, the present invention is susceptible of broad utility and application. Many adaptations of the present invention other than those herein described, as well as many variations, modifications, and equivalent arrangements will be apparent from or reasonably suggested by the present invention and the above detailed description thereof, without departing from the substance or scope of the present invention.

What is claimed is:

1. A dental implement comprising a yarn consisting essentially of a botanic fiber.

2. The dental implement of claim 1, wherein the botanic fiber comprises a soybean protein fiber.

3. The dental implement of claim 2, further comprising a surfactant, a fluoridating treatment, a medicinal agent, an antimicrobial agent, a flavoring, a coating that alters the coefficient of friction of the yarn, or any combination thereof.

4. A dental implement comprising silk and botanic fiber.

5. The dental implement of claim 4, wherein the botanic fiber comprises soybean protein fiber.

6. The dental implement of claim 4, wherein the botanic fiber is present in an amount of from about 5 wt % to about 95 wt % of the dental implement.

7. The dental implement of claim 4, wherein the botanic fiber is present in an amount of from about 25 wt % to about 75 wt % of the dental implement.

8. The dental implement of claim 4, wherein the botanic fiber is present in an amount of from about 40 wt % to about 60 wt % of the dental implement.

9. The dental implement of claim 4, wherein the silk is present in an amount of from about 5 wt % to about 95 wt % of the dental implement.

10. The dental implement of claim 4, wherein the silk is present in an amount of from about 25 wt % to about 75 wt % of the dental implement.

11. The dental implement of claim 4, wherein the silk is present in an amount of from about 40 wt % to about 60 wt % of the dental implement.

12. A dental floss comprising a plurality of fibers, wherein the plurality of fibers consist essentially of soybean protein fiber and silk.

13. The dental implement of claim 12, wherein the weight ratio of soybean protein fiber to silk is from about 9:1 to about 5:1.

14. The dental implement of claim 12, wherein the weight ratio of soybean protein fiber to silk is from about 6:1 to about 3:1.

15. The dental implement of claim 12, wherein the weight ratio of soybean protein fiber to silk is from about 4:1 to about 1:1.

16. The dental implement of claim 12, wherein the weight ratio of silk to soybean protein fiber is from about 9:1 to about 5:1.

17. The dental implement of claim 12, wherein the weight ratio of silk to soybean protein fiber is from about 6:1 to about 3:1.

18. The dental implement of claim 12, wherein the weight ratio of silk to soybean protein fiber is from about 4:1 to about 1:1.

19. A method of making a dental floss comprising:
forming a yarn comprising a botanic fiber and silk;
applying a coating to the yarn.

20. The method of claim 19, wherein
the botanic fiber is soybean fiber; and
the coating is selected from the group consisting of a surfactant, a fluoridating treatment, a medicinal agent, an antimicrobial agent, a flavoring, a coating that alters the coefficient of friction of the floss, and any combination thereof.
